(19) United States
(12) Patent Application Publication
(10) Pub. No.: US 2002/0015233 A1
(43) Pub. Date: Feb. 7, 2002

(54) Optical system for head mounted display

(75) Inventor: Bu Go Park, Bucheon-si (KR)

Correspondence Address: LOWE HAUPTMAN GOPSTEIN, GILMAN & BERNER, LLP, SUITE 310, 1700 DIAGONAL ROAD, ALEXANDRIA, VA, 22314, US

(73) Assignee: DAEYANG E&C CO., LTD.

(21) Appl. No.: 09/916,266

(22) Filed: Jul. 30, 2001

(30) Foreign Application Priority Data
Jul. 31, 2000 (KR) 2000-44297

(51) Int. Cl. G02B 27/14

(52) U.S. Cl. 359/630; 359/629; 359/631; 359/632

(57) ABSTRACT

The present invention relates to a head mounted display that is constructed such that stereoscopic images can be seen on a liquid crystal display screen disposed adjacent to two human eyes. The present invention provides an optical system for a head mounted display, comprising a light source; a light guide panel which has a side portion, a top portion and a bottom portion, which receives light rays emitted from the light source through the side portion, reflects the light rays substantially perpendicular to a direction of the light rays, and emits the light rays toward the top portion, and which emits most of the light rays incident on the top portion through the bottom portion; a frontlight liquid crystal display screen which is disposed to face the top portion of the light guide panel and on which images are displayed by reflecting the light rays emitted from the top portion of the light guide panel and causing the light rays to be incident on the top portion of the light guide panel; and a free-form-surface prism disposed in front of the bottom portion of the light guide panel for magnifying the images on the liquid crystal display screen by reflecting and focusing the light rays which are reflected from the frontlight liquid crystal display screen and emitted toward the bottom portion of the light guide panel. According to the an optical system for a head mounted display of the present invention, there is an advantage in that its production costs can be reduced, since the optical system for the head mounted display of the present invention employs the frontlight liquid crystal display screen which is inexpensive and has a high pixel density. Further, there is another advantage in that the use efficiency of the light source can be enhanced, since the optical system of the present invention includes the inexpensive light emitting diode and the light guide panel for reflecting the light rays emitted from the light emitting diode and focusing the light rays within a range of the predetermined angles.

### BACKGROUND OF THE INVENTION

1. Field of the Invention

The present invention relates to a head mounted display which is constructed such that stereoscopic images can be seen on a liquid crystal display screen disposed adjacent to eyes, and more particularly, to an optical system for the head mounted display wherein its production costs can be reduced and best images can be provided to a wearer by enhancing use efficiency of a light source.

2. Description of the Prior Art

A head mounted display includes an optical system comprising a liquid crystal display screen, an illuminating device, lenses, etc. This optical system allows images to be displayed on the liquid crystal display screen and can be variously constructed depending on an arrangement of the components for constituting the optical system. Examples of the optical system used generally in the prior art are schematically shown in FIGS. 1 and 2. Taking the figures into consideration, the optical system of FIG. 1 is constructed in such a manner that an illuminating device 2 serving as a light source of a liquid crystal display screen 1 for displaying images is disposed behind the liquid crystal display screen 1 and that an eye lens 3 is disposed in front of the liquid crystal display screen 1.

Further, the optical system of FIG. 2 is constructed in such a manner that a liquid crystal display screen 1 is horizontally disposed to face downward, that a polarization beam splitter 4 is disposed at an angle of about 45° and vertically below the liquid crystal display screen 1, and that a concave reflecting mirror 5 for magnifying and reflecting an image displayed on the liquid crystal display screen 1 is disposed behind the polarization beam splitter 4. Here, an illuminating device 2 is also disposed behind the liquid crystal display screen 1 in the same manner as in FIG. 1. Furthermore, the liquid crystal display screens 1 of FIGS. 1 and 2 are backlight liquid crystal display screens and can be used to display the image by using the illuminating device 2, disposed behind the screens, as a light source.

Although the conventional optical systems constructed as such have advantages in that their constitutions are simple and thus their production costs are low, there are still disadvantages in that the eye lens 3 should be thick since a focal length thereof must be shortened to realize a large screen and that it is necessary to secure sufficient spaces for installing the illuminating device 2 and the polarization beam splitter 4. In particular, although the optical system of FIG. 2 has a more advantageous effect than the optical system of FIG. 1 in that image visibility thereof can be enhanced by means of the polarization beam splitter 4, there is a problem in that a wearer's own eye shape is reflected onto and seen from the concave reflecting mirror 5.

Another example of an optical system for a head mounted display is shown in FIG. 3. This optical system is constructed in such a manner that a liquid crystal display screen 1 is disposed to face downward at an angle of about 45°, an illuminating device 2 is disposed behind the liquid crystal display screen 1, and a free-form-surface prism 6 is disposed in front of the liquid crystal display screen 1. The liquid crystal display screen 1 is also a backlight liquid crystal display like those of FIGS. 1 and 2. The liquid crystal display screen 1 is constructed in such a manner that it displays an image by using the illuminating device 2, disposed behind the screens, as a light source and that light rays emitted from the liquid crystal display screen 1 are directed to a plane of incidence of the free-form-surface prism 6. On the other hand, the free-form-surface prism 6 is a polyhedron having a plane of incidence 6a, a plane of reflection 6b and a light-emerging plane 6c. As viewed from the outside, the plane of incidence 6a and the light-emerging plane 6c are concave while the plane of reflection 6b is convex. The free-form-surface prism 6 serves to magnify the image on the liquid crystal display screen 1 by reflecting and converging the light rays emitted from the liquid crystal display screen 1. That is, the light rays, which have been emitted from the liquid crystal display screen 1 and then are incident on the plane of incidence 6a, are reflected by the plane of reflection 6b and the light-emerging plane 6c and subsequently are converged into a focus, as shown in FIG. 3. Thus, there is an effect that the eyes of the wearer seem to view a large screen.

On the other hand, since the optical system of FIG. 3 constructed as such has a constitution in which its components are arranged nearly vertically, it is not necessary to secure large horizontal spaces. Thus, it has an advantage of its slimness and compactness. However, there is a shortcoming in that the production costs are increased since the expensive backlight liquid crystal display screen 1 should be used. Further, there is also another shortcoming in that a light source having a large area is required since the light source should be provided to an entire rear surface of the backlight liquid crystal display screen 1.

### SUMMARY OF THE INVENTION

Accordingly, the present invention is contemplated to solve the above problems. An object of the present invention is to provide an optical system for a head mounted display, wherein the structure of the optical system is improved so that inexpensive parts can be used therein and thus its production costs can be reduced, and wherein use efficiency of the light source can be enhanced and best images can be provided to a wearer.

In order to achieve the above object, the present invention provides an optical system for a head mounted display, An optical system for a head mounted display, comprising a light source; a light guide panel which has a side portion, a top portion and a bottom portion, which receives light rays emitted from the light source through the side portion, reflects the light rays substantially perpendicular to an incident direction of the light rays, and emits the light rays toward the top portion, and which emits most of the light rays incident on the top portion through the bottom portion; a frontlight liquid crystal display screen which is disposed to face the top portion of the light guide panel and on which images are displayed by reflecting the light rays emitted from the top portion of the light guide panel and causing the light rays to be incident on the top portion of the light guide panel; and a free-form-surface prism disposed in front of the bottom portion of the light guide panel for magnifying the images on the liquid crystal display screen by reflecting and focusing the light rays which are reflected from the frontlight liquid crystal display screen and emitted toward the bottom portion of the light guide panel.

### BRIEF DESCRIPTION OF THE DRAWINGS

FIG. 1 is a schematic view showing the constitution of a conventional optical system for a head mounted display.

FIGS. 2 and 3 are schematic views showing the other examples of conventional optical systems for a head mounted display.

FIG. 4 is a schematic view showing the constitution and arrangement of an optical system for a head mounted display according to the present invention.

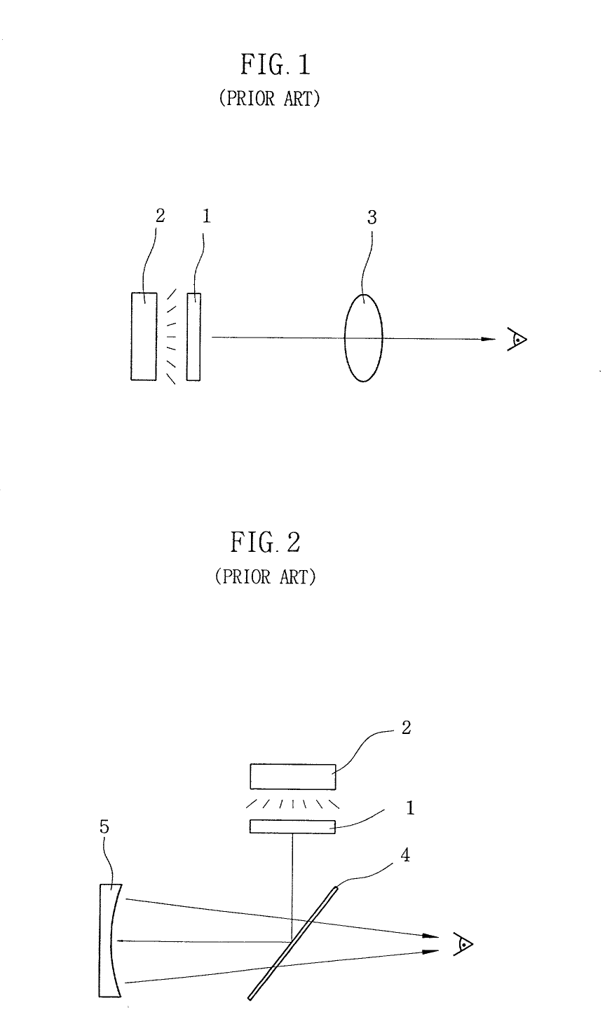

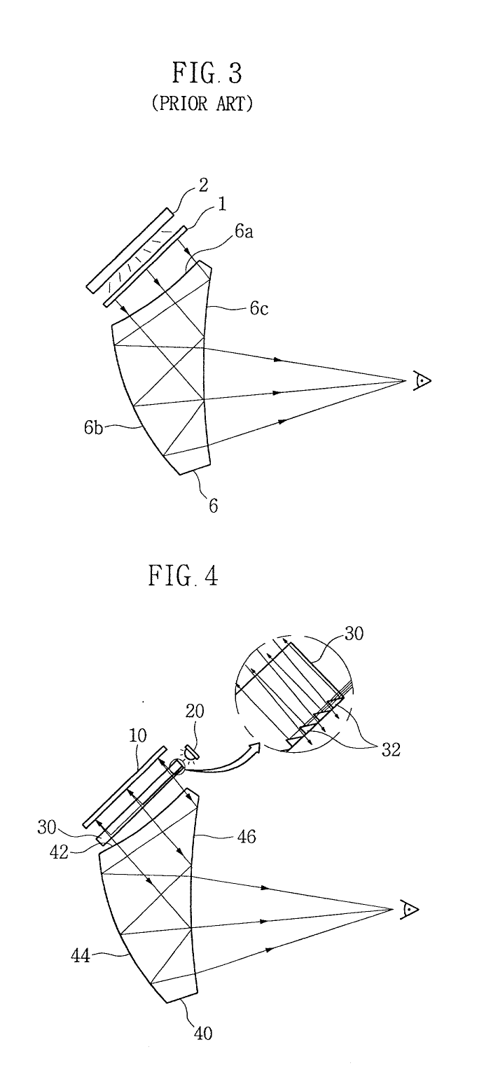

### DETAILED DESCRIPTION FOR PREFERRED EMBODIMENT

Hereinafter, a preferred embodiment of an optical system for a head mounted display according to the present invention will be explained in detail with reference to the accompanying drawings.

FIG. 4 is a view showing schematically the constitution and arrangement of the optical system for the head mounted display according to the present invention. First, as shown in FIG. 4, the optical system for the head mounted display according to the present invention includes a liquid crystal display screen 10, as a component thereof, for displaying an image. The liquid crystal display screen 10 is a high pixel density frontlight liquid crystal display screen for displaying the image by using irradiation from a light source disposed in front of the screen, and is disposed to face downward at an angle of about 45°. Since the frontlight liquid crystal display screen has been well known, the detailed description thereof will be omitted.

Further, a red/green/blue (RGB) light emitting diode 20 is disposed at one side of the liquid crystal display screen 10, and a light guide panel 30 is disposed in front of the liquid crystal display screen 10. The RGB light emitting diode 20 is used for providing the liquid crystal display screen 10 with the light source, and the light guide panel 30 is used for reflecting and irradiating the light emitted from the light emitting diode 20 onto the liquid crystal display screen 10. Here, the light guide panel 30 includes a side portion, a top portion, and a bottom portion. As shown in FIG. 4, fine waves 32 are formed on a surface of the bottom portion of the light guide panel 30. Thus, the light guide panel 30 has the characteristics that light rays irradiated to a side face thereof are reflected onto the top portion thereof substantially perpendicular to the irradiated direction of the light rays and that light rays irradiated in front of the light panel is introduced into the top portion thereof, transmitted directly, and emitted through the bottom portion. Further, the light guide panel 30 has the characteristics that transmission of the light rays can be made without light loss while minimizing light attenuation in undesired directions, since the light rays irradiated to the side face of the panel can be reflected as such and diffused light rays can also be focused within a predetermined range of angles.

The light guide panel 30 causes the light rays emitted from the light emitting diode 20 to be reflected and focused, and irradiates the light rays onto an entire surface of the liquid crystal display screen 10. Further, the panel 30 causes the light rays of the images emitted from the liquid crystal display screen 10 to be directly transmitted. In particular, the light guide panel 30 serves to enhance use efficiency of the light source to the utmost, by causing the light rays emitted from the light emitting diode 20 to be transmitted to the liquid crystal display screen 10 while minimizing loss of the light rays in the undesired directions.

On the other hand, a free-form-surface prism 40 is used as a main component in the present invention. The free-form-surface prism 40 is a polyhedron having a plane of incidence 42, a plane of reflection 44 and a light-emerging plane 46. The plane of incidence 42 and the light-emerging plane 46 are concave while the plane of reflection 44 is convex. The free-form-surface prism 40 is vertically disposed with the plane of incidence 42 placed in front of the light guide panel 30. Further, the free-form-surface prism 40 serves to magnify the image on the liquid crystal display screen 10, which is introduced through the plane of incidence 42. Particularly, the light rays of the image on the liquid crystal display screen 10 are reflected many times by the concave plane of incidence 42, the concave light-emerging plane 46 and the convex plane of reflection 44. After the light rays emerge from the light-emerging plane, they converge into a predetermined focus. Thus, the image on the liquid crystal display screen can be magnified and viewed.

With such constitution, when the light rays are emitted from the light emitting diode 20 with signals applied to the liquid crystal display screen 10, they are reflected at a predetermined angle by the light guide panel 30 and irradiated to the liquid crystal display screen 10. At this time, the light rays emitted from the light emitting diode 20 are reflected by the light guide panel 30 and also focused with the predetermined range of angles. Then, the light rays are irradiated uniformly over the entire surface of the liquid crystal display screen 10. Accordingly, the liquid crystal display screen 10 can display the image by using the light rays as the light source.

On the other hand, the light rays of the image on the liquid crystal display screen 10 are transmitted by the light guide panel 30 and are incident on the free-form-surface prism 40. The light rays incident on the free-form-surface prism 40 are reflected many times by the plane of incidence 42, the plane of reflection 44 and the light-emerging plane 46. Finally, when the light rays emerge forward from the light-emerging plane 46, they converge into the predetermined focus. Thus, a wearer of the head mounted display can view an image magnified from the image on the liquid crystal display screen 10, through the light-emerging plane 46 of the free-form-surface prism 40.

As described above, since the optical system for the head mounted display of the present invention employs the frontlight liquid crystal display screen which is inexpensive and has a high pixel density, there is an advantage in that its production costs can be reduced. Further, since the optical system of the present invention includes the inexpensive light emitting diode and the light guide panel for reflecting the light rays emitted from the light emitting diode and focusing the light rays within a predetermined range of angles, there is another advantage in that the use efficiency of the light source can be enhanced.

The aforementioned embodiment is merely a preferred embodiment of the present invention, and is not to be construed as limiting the scope of the present invention. Various modifications and changes can be made thereto within the spirit of the present invention. Therefore, the scope of the present invention should be defined by the appended claims and equivalents thereof.

What is claimed is:

1. An optical system for a head mounted display, comprising:
a light source;
a light guide panel which has a side portion, a top portion and a bottom portion, which receives light rays emitted from said light source through said side portion, reflects said light rays substantially perpendicular to an incident direction of said light rays, and emits said light rays toward said top portion, and which emits most of said light rays incident on said top portion through said bottom portion;
a frontlight liquid crystal display screen which is disposed to face said top portion of said light guide panel and on which images are displayed by reflecting said light rays emitted from said top portion of said light guide panel and causing said light rays to be incident on said top portion of said light guide panel; and
a free-form-surface prism disposed in front of said bottom portion of said light guide panel for magnifying said images on said liquid crystal display screen by reflecting and focusing said light rays which are reflected from said frontlight liquid crystal display screen and emitted toward said bottom portion of said light guide panel.

2. The optical system for the head mounted display as claimed in claim 1, wherein said light source is a light emitting diode which is disposed to emit said light rays toward said side portion of said light guide panel.
